(19) United States
(12) Patent Application Publication
(10) Pub. No.: US 2009/0307745 A1
(43) Pub. Date: Dec. 10, 2009

(54) DOCUMENT MANAGEMENT APPARATUS, POLICY SERVER, METHOD FOR MANAGING DOCUMENT, METHOD FOR CONTROLLING POLICY SERVER, AND COMPUTER-READABLE RECORDING MEDIUM

(75) Inventor: Koji Inose, Saitama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/478,132

(22) Filed: Jun. 4, 2009

(30) Foreign Application Priority Data
Jun. 6, 2008 (JP) 2008-149364

(51) Int. Cl. G06F 17/00; G06F 21/24

(52) U.S. Cl. 726/1; 726/27

(57) ABSTRACT

A document management apparatus is included in a document management system having a policy server which issues a policy corresponding to a right to access a document. The document management apparatus has an access-right description determination unit configured to collate first data input in the document with an access-right description defined in accordance with second data input in the document in advance, and determine the access-right description for the document in which the first data is input in accordance with a result of the collation, a requesting unit configured to request the policy server to issue the policy in accordance with the access-right description determined using the access-right description determination unit, and an applying unit configured to apply the policy issued by the policy server to the document in which the first data is input.

### BACKGROUND OF THE INVENTION

1. Field of the Invention

The present invention relates to a document management apparatus which is used to input data in a template when a form is to be generated, and which is used to generate a document in accordance with the data, as well as a policy server, a method for managing the document, a method for controlling the policy server, and a computer-readable recording medium therefor.

2. Description of the Related Art

In recent years, access-right management servers which set rights of access to documents (e.g., a right of viewing, a right of editing, and a right of printing, for example) have been developed in order to prevent information in the documents from being leaked.

When such a server is used, an expiration date of a document can be set. After the set expiration date, any set access right becomes invalid.

A known example of the access-right management server which manages rights of access to documents includes a policy server (LiveCycle® ES Rights Management) developed by Adobe® Systems Incorporated.

This policy server issues a policy for a PDF (Portable Document Format) file, which is a type of document, and applies the policy to the document to thereby set an access right and an expiration date.

In general, systems in companies have been shifted to serverless decentralized systems.

Under this circumstance, a system is designed such that a multifunction device and an operation terminal, such as a PC, perform a large part of the document management necessary for mission-critical tasks, and thus this system is not trivial.

The document management for mission-critical tasks includes generation of forms such as bill statements, estimation sheets, and expense sheets.

An example of a type of template that may be required for the generation of forms includes a PDF form, developed by Adobe® Systems Incorporated, which has fields allowing users to directly input data.

When the PDF form is displayed using an operation terminal and data is input in the fields, that is, a customer name and a name of a person in charge are input in an estimation sheet, for example, a form is generated in an on-demand manner in the operation terminal without using a dedicated server.

Then, it is expected that the generated form may be easily transmitted from the operation terminal to a user terminal.

The form is often generated for a specific user due to the content thereof, and therefore, access thereto may be restricted where appropriate.

When the operation terminal has a policy which is appropriate for the form, the policy is applied to the form. However, the operation terminal generally only has a policy included in a template.

In general, the template has a characteristic in which description thereof can be changed in an on-demand manner. Therefore, the policy assigned to the template has a minor restriction on editing performed by the user. Alternatively, the operation terminal may not have any policies.

Therefore, it is not appropriate that the policy assigned to the template is applied to the form.

Japanese Patent Laid-Open No. 2003-6028 discloses a technique of, when a document is modified, restricting users who are allowed to view the document and a viewing range by encrypting a modified portion.

Furthermore, Japanese Patent Laid-Open No. 2004-178334 discloses a technique of, when data is input in a specific field of a template, restricting terminals which can access a generated form in accordance with the input data.

Even in a case where the technique disclosed in Japanese Patent Laid-Open No. 2003-6028 is employed, for example, when a large number of documents are stored in the operation terminal, access restriction should be performed on (i.e., policies should be assigned to) every document by a system administrator. This can be troublesome for the system administrator.

On the other hand, in a case where the technique disclosed in Japanese Patent Laid-Open No. 2004-178334 is employed, rights of accessing the documents stored in the operation terminal are controlled (that is, policies are assigned) in accordance with data input in the field, and therefore, this may not be as troublesome for the system administrator.

However, with this technique, a target to be managed is the terminal which allows the user to view the document and which is capable of performing printing, and therefore, the technique is not suitable for managing documents, such as forms, which it may be possible to view or print using an arbitrary terminal.

### SUMMARY OF THE INVENTION

According to an exemplary embodiment of the present invention, there is provided a document management apparatus included in a document management system having a policy server which issues a policy corresponding to a right of accessing to a document. The document management apparatus has an access-right description determination unit configured to collate first data input in the document with an access-right description defined in accordance with second data input in the document in advance, and determine the access-right description for the document in which the first data is input in accordance with a result of the collation, a requesting unit configured to request the policy server to issue the policy in accordance with the access-right description determined using the access-right description determination unit, and an applying unit configured to apply the policy issued by the policy server to the document in which the first data is input.

According to another exemplary embodiment of the invention, a policy server is provided which is included in a document management system having a document management apparatus and which issues a policy corresponding to a right to access a document. The policy server includes a reception unit configured to receive data which is input in the document using the document management apparatus, data representing an identifier of a template which is used to generate the document to which the data is input, and data representing a field identifier, an access-right description determination unit configured to collate the data received using the reception unit with an access-right description defined in accordance with data input in the document in advance, and determine the access-right description for the document in which the data is input in accordance with a result of the collation, and an issuing unit configured to issue the policy to the document management apparatus in accordance with the access-right description determined using the access-right description determination unit.

Further features of the present invention will become apparent from the following description of exemplary embodiments with reference to the attached drawings.

### BRIEF DESCRIPTION OF THE DRAWINGS

FIG. 1 is a diagram illustrating a module configuration according to an embodiment of the invention.

FIG. 2 is flowchart illustrating an example of operation of a policy server.

FIG. 3 is a flowchart illustrating an example of a process employing a policy.

FIG. 4 is a flowchart illustrating an example of a process of accessing to a document.

FIG. 5 is a flowchart illustrating another example of a process of accessing to the document.

FIG. 6 shows a data input screen before data is input according to an embodiment of the invention.

FIG. 7 shows a data input screen after data is input according to an embodiment of the invention.

FIG. 8 is an example of a table used to determine an access-right description.

FIG. 9 shows an example of a form.

FIG. 10 shows a user interface used to set usage of an access-right determination server according to an embodiment of the invention.

FIG. 11 is a flowchart illustrating an example of a process of making an inquiry to the server about the access-right description using a client computer.

FIG. 12 is a flowchart illustrating an example of a process of requesting determination of the access-right description performed by the server.

FIG. 13 shows a data input screen after data is input according to an embodiment of the invention.

FIG. 14 shows another data input screen after data is input according to an embodiment of the invention.

FIG. 15 shows a user interface used to select a process of only checking an access right or a process of determining a policy according to an embodiment of the invention.

FIG. 16 shows a user interface notifying that the policy is being changed according to an embodiment of the invention.

FIG. 17 is a flowchart illustrating an example of a process of only checking an access right or the process of determining a policy.

FIG. 18 shows a user interface notifying that an access right cannot be determined according to an embodiment of the invention.

FIG. 19 is a flowchart illustrating an example of a process performed when the access right cannot be determined.

### DESCRIPTION OF THE EXEMPLARY EMBODIMENTS

Terms used in a first exemplary embodiment will be defined hereinafter.

### (1) To Access

“To access to a document” includes any one or more of:

to display a document by a client computer in accordance with a display instruction input by a user;

to edit a document by a client computer in accordance with an editing instruction input by a user; and

to transmit an instruction for printing a document from a client computer to a printing device in accordance with a printing instruction input by a user.

Each of the display instruction, the editing instruction, and the printing instruction may be referred to as an “access instruction”.

### (2) Access Right

A “right to access a document” is a right to make a client computer execute a process (e.g., a process performed on a document) in response to an access instruction. A state in which the client computer is allowed to execute the process (the process performed on a document) in accordance with the access instruction input by a specific user or an arbitrary user is referred to as a state in which the user has a right to access the document. Furthermore, a state in which the client computer is not allowed to execute the process (the process performed on a document) in accordance with an access instruction input by a specific user or an arbitrary user is referred to as a state in which the user does not have a right to access the document. This access right includes one or more of a right to view the document (hereinafter referred to as a “viewing right”), a right to edit the document (hereinafter referred to as an “editing right”), and a right to print the document (hereinafter referred to as a “printing right”).

### (3) To Set Access Right

“To set an access right” means, on a conceptual basis, to assign an access right to a specific user or an arbitrary user so that the user can access a specific document. “To set an access right” means, as a process, a process of generating and storing a file used to associate an access right with user information (e.g., information which specifies the specific user or the arbitrary user), and applying the file to the document.

### (4) Policy

A “policy” refers to the file described above which indicates the association between the access right and the user information. Therefore, “to generate and store a policy” and “to apply the policy to a document” are included in “to set a right to access the document”.

### (5) Policy Server

A “policy server” corresponds to a server device which generates and stores a policy. A process to generate and store a policy for a specific document may be referred to as issuing a policy (for a specific document).

### Configuration

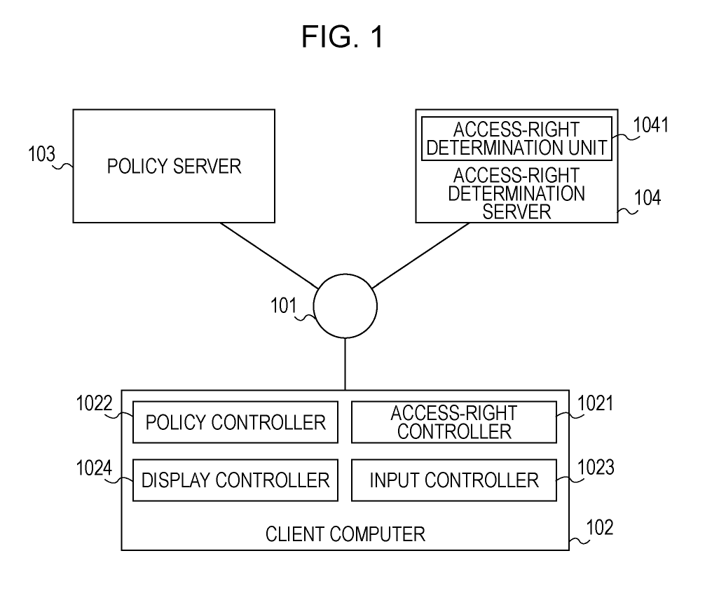

FIG. 1 is a configuration diagram suitably used to describe this exemplary embodiment of the present invention.

A document management system according to this embodiment includes a network 101, a client computer 102, a policy server 103, and an access-right determination server 104.

The network 101 functions as a communication line used to transmit and receive information among the devices described above. The network 101 may correspond to, for example, a communication line network complying with a TCP/IP protocol, and may be a wired communication line or a wireless communication line.

The client computer 102 corresponds to a document management apparatus, and may include an access-right controller 1021, a policy controller 1022, an input controller 1023, and a display controller 1024.

The access-right controller 1021 is capable of making an inquiry to the access-right determination server 104 about information on a detailed description of an access right, that is, information on an operation which may be instructed by a user, in accordance with data specified by the user.

The policy controller 1022 may correspond to, for example, Acrobat® developed by Adobe® Systems Incorporated. The policy controller 1022 according to this embodiment transmits an access-right description obtained using the access-right controller 1021 to the policy server 103, receives an identifier of a policy, and applies the received identifier to a document.

The input controller 1023 performs a process in accordance with data input by the user or an instruction input using a dialog operation. The display controller 1024 displays interfaces used for data input, messages, and dialogs.

The access-right determination server 104 includes an access-right determination unit 1041 which determines a detailed description of an access right (hereinafter referred to as an “access-right description”) in accordance with information transmitted from the client computer 102, and transmits the access-right description to the client computer 102.

Note that the access-right determination unit 1041 may also be included in the client computer 102.

In this case, the access-right determination unit 1041 cooperatively operates with the access-right controller 1021 so as to determine the access-right description.

Furthermore, the access-right determination unit 1041 may also be included in the policy server 103. In this case, a policy is generated in the policy server 103 in accordance with the access-right description, and an identifier of the policy is transmitted to the client computer 102.

However, in this exemplary embodiment, the configuration shown in FIG. 1 is employed for simplicity of description.

### Process of Determining Access-Right Description

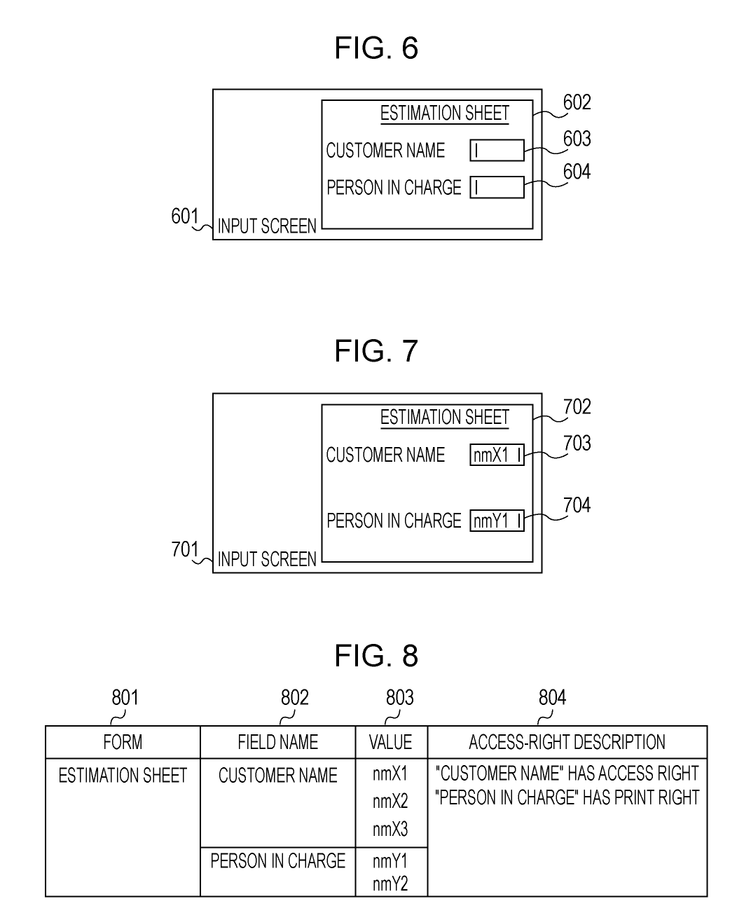

A process of determining an access-right description that may be required when the client computer 102 requests the policy server 103 to issue a policy will be described with reference to FIGS. 6, 7, 8, 9, 11, and 12.

FIG. 6 shows an example of an input screen of the client computer 102 before data is input in fields of a template by a user.

FIG. 7 shows an example of an input screen of the client computer 102 after the data is input in the fields of the template by the user.

In this way, a document may be generated by inputting data in the field of the template.

FIG. 8 shows an example of a table listing information used to determine an access-right description.

This table may be included in the access-right determination unit 1041 in the access-right determination server 104.

The table can be managed by an administrator of the system and stored in the access-right determination unit 1041 in advance.

The table includes a type of template 801, a field name 802, data 803 input in the field.

The table further includes an access-right description 804 which is defined by the information described above, that is, the type of template 801, the field name 802, the data 803.

A type of access right is determined in accordance with the access-right description 804 when certain data is input in a field of a certain template.

That is, detailed information on the authority that the user has when certain data is input in a field of a certain template is written in the access-right description 804.

It is assumed that a value nmX1 and a value nmY1 are input in a column of a customer name and a column of a person in charge, respectively.

The input values are collated with the access-right description defined in accordance with the data input in the document in advance.

With this collation, detailed access rights given to individual users, for example, a viewing right given to a person corresponding to the data nmX1, or a printing right given to a person corresponding to the data nmY1, become apparent.

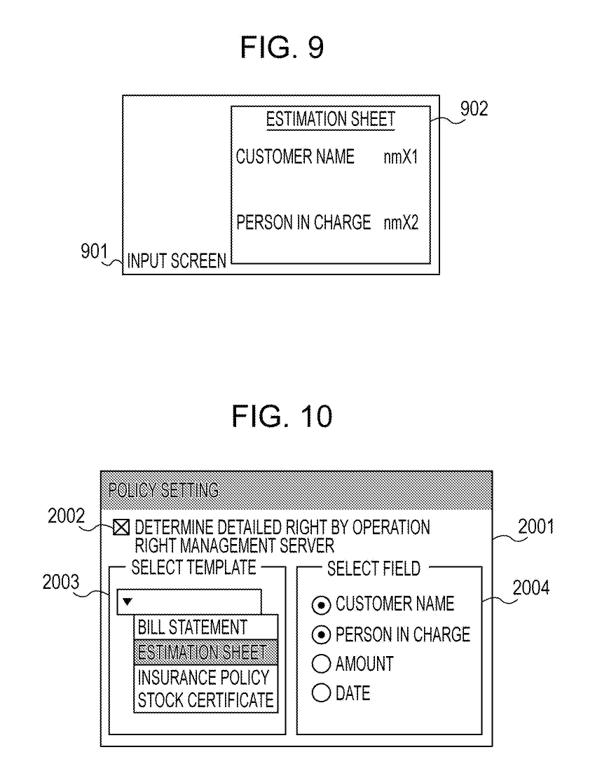

In FIG. 9, a reference numeral 901 denotes an input screen and a reference numeral 902 denotes a document in which data is input in a field and to which a policy is finally applied.

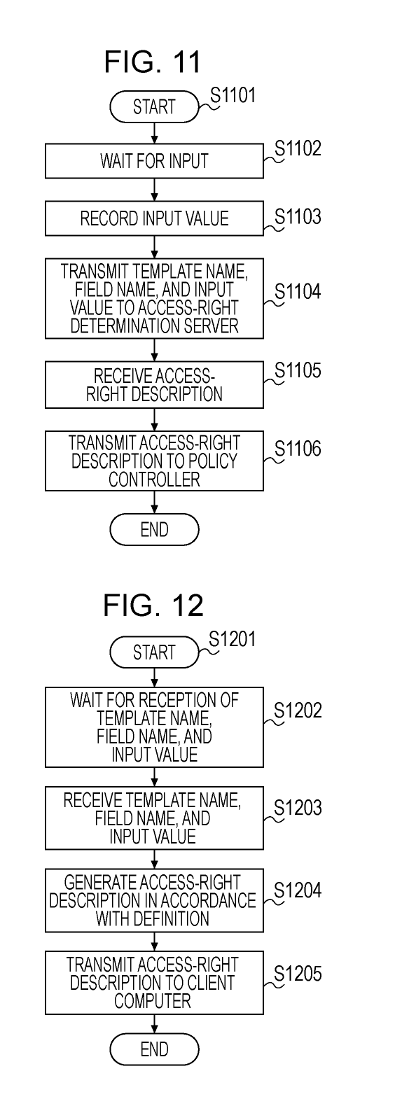

FIG. 11 is a flowchart illustrating an example of a process of requesting the access-right determination server 104 to determine the detailed access-right description mainly using the access-right controller 1021.

FIG. 12 is a flowchart illustrating an example of a process of determining the access-right description performed using the access-right determination unit 1041.

Referring now to FIG. 11, an example of the process of requesting the determination of the access-right description will be described.

The process starts in step S1101.

In step S1102, the display controller 1024 performs a display operation as shown in FIG. 6, and waits for data input by the user.

An input screen 601 to which data is input by the user includes a template 602 of a document to be generated.

The template 602 includes fields 603 and 604 which allow the user to input data and are in states in which data to be input has not been determined.

FIG. 7 shows an input screen 701 after data is input. As with the input screen 601, the input screen 701 includes a template 702.

The input screen 701 further includes fields 703 and 704 which allow the user to input data and are in states in which specific data has been determined. After the data is input, the process proceeds to step S1103.

In step S1103, the input controller 1023 performs an operation for recording the data input by the user using the interface used for data input.

In step S1104, the input controller 1023 receives the data input by the user, a template identifier used to identify the template 602, and a field identifier used to identify a field to which the data has been input. Then, the data, the template identifier, and the field identifier are transmitted to the access-right determination server 104.

Note that a process of determining the “access-right description” in which detailed access rights are written, as performed using the access-right determination server 104, will be described later with reference to FIG. 12 (S1201 to S1205). In step S1105, an access-right description in which access rights are described in detail is received.

In step S1106, the access-right description received using the access-right controller 1021 is transferred to the policy controller 1022, and the process is thus terminated.

Referring to FIG. 12, an example of the process of determining the access-right description performed by the access-right determination server 104 will be described.

The process starts in step S1201.

In step S1202, the display controller 1024 waits for data input by the user.

In step S1203, the access-right determination server 104 receives the data input by the user, the template identifier used to identify the document template, and the field identifier used to identify the field to which the data is input from the client computer 102.

In step S1204, the access-right determination unit 1041 collates the data items received in step S1203 with the type of template 801, the field name 802, and the data 803 included in the table stored therein.

When a definition is written in the access-right description 804 which is associated with the data items which match the data items included in the stored table, the definition is transmitted to the client computer 102 in step S1205.

For example, the template 702 “estimation sheet” is received as the identifier used to identify the template, and is collated with the data included in the type of template 801.

Then, the data “nmX1” included in the field 703 as an example and the field identifier “customer name” are received and are collated with the value included in the data 803, and the data included in the field name 802 respectively.

In addition, the data “nmY1” included in the field 704 as an example and the field identifier “person in charge” are received and are collated with the value included in the data 803, and the data included in the field name 802 respectively.

By this process, it can be determined that the access-right description 804 which is associated with the data items included in the type of template 801, the field name 802, and the data 803, is included in the table. That is, a definition in which a user named “nmX1” input in the field of “customer name” is allowed to view the estimation sheet, and a user named “nmY1” input in the field of “person in charge” is allowed to print the estimation sheet, is included in the access-right description.

On the basis of this definition, information representing that the user named “nmX1” input in the field of “customer name” is allowed to view the estimation sheet, and the user named “nmY1” input in the field of “person in charge” is allowed to print the estimation sheet, or similar information, is transmitted to the client computer 102.

The access-right controller 1021 included in the client computer 102 which has received the information transfers the received information to the policy controller 1022, as described above.

That is, an appropriate access-right description can be defined for a document generated by inputting the data “nmX1” and the data “nmY1” in the field of “customer name” and the field of “person in charge”, respectively, included in the template of the estimation sheet.

In this case, a plurality of possible combinations of a type of field of the template and data to be input to the field can be considered.

For a document having the plurality of possible combinations, a request for issuing an appropriate policy for each combination may be performed by defining detailed access-right descriptions for the individual combinations of the document.

Note that the information shown in FIG. 8 which is used to determine the access-right description and which is included in the access-right determination unit 1041 may be included in the template.

In this case, the client computer 102 determines the access-right description.

Furthermore, when the access-right determination unit 1041 is included in the policy server 103, the data input using the client computer 102 is transmitted to the access-right determination unit 1041 included in the policy server 103.

Then, the policy server 103 issues the policy in accordance with the definition included in the access-right description determined using the access-right determination unit 1041.

### Process of Issuing Policy Based on Access-Right Description

A process of issuing a policy on the basis of an access right determined as described above will be described.

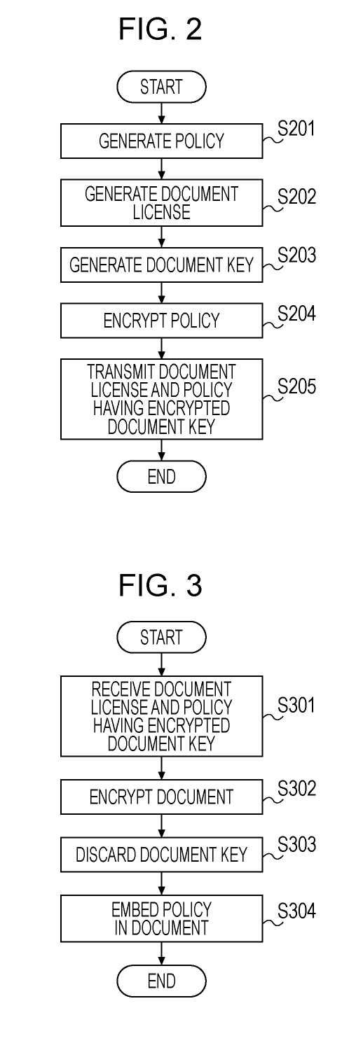

FIG. 2 is a flowchart illustrating an example of a process of issuing a policy performed by the policy server 103. FIG. 3 is a flowchart illustrating an example of a process performed by the client computer 102 when the policy is applied to a document (a PDF file, for example).

When receiving an instruction for generation of a policy (hereinafter referred to as a “policy generation instruction”) input by the user, the client computer 102 notifies the policy server 103 of the reception of the instruction.

The policy generation instruction includes an instruction for generation of a policy and an instruction for specifying a policy to be generated.

The instruction for specifying a policy to be generated corresponds to an instruction for specifying an access right to be given to each user. Therefore, this instruction corresponds to the access-right description described above.

When the policy server 103 receives the policy generation instruction, an operation of step S201 starts.

In step S201, the policy server 103 generates a policy for a specified document in accordance with the policy generation instruction and stores the policy.

Note that the policy corresponds to a file representing an access right to be given to a user having a user ID.

In other words, the policy corresponds to a file representing an association between user information and an access right.

In step S202, the policy server 103 generates a document license including policy server identifying information (information used to uniquely identify a policy server, for example, an IP address), and policy identifying information (information used to identify a policy stored in the policy server, for example, an ID).

In step S203, the policy server 103 assigns an electronic signature to the document license so that data consistency may be provided.

Furthermore, the policy server 103 generates a document key (an encryption key) to be used to encrypt the document.

The document key is generated for each document to which a policy is applied. In this exemplary embodiment, the document key is generated only for the specified document.

In step S204, the policy server 103 encrypts the policy generated in step S201.

In step S205, the policy server 103 associates the document license, the document key, and the encrypted document with one another and transmits them to the client computer 102. Furthermore, in step S205, the encrypted policy, the policy identifying information, and the document key which are transmitted to the client computer 102, are associated with one another and are stored in the policy server 103.

In step S301, the client computer 102 receives the document license, the document key, and the encrypted policy which are associated with one another from the policy server 103. Then, the policy controller 1022 which is included in the client computer 102 and in which Acrobat® provided by Adobe® Systems Incorporated is installed, applies the received policy to the specified document.

An example of a process of applying the policy to the specified document is described in step S302, step S303, and step S304.

In step S302, the policy controller 1022 included in the client computer 102 encrypts the document using the received document key. After the encryption, the process proceeds to step S303.

In step S303, the policy controller 1022 included in the client computer 102 determines that the document key is no longer necessary since the encryption is completed, and the policy controller 1022 discards the document key.

In step S304, the policy controller 1022 included in the client computer 102 embeds the document license and the encrypted policy in the encrypted document. The process of applying the policy to the document is thus terminated.

As described above, the policy which is issued in accordance with the access-right description defined in accordance with the type of template and the input data is applied to the document generated in accordance with the template.

### Access to Document Used in On-Line Environment

Certain embodiments of the present invention may not directly relate to a process of accessing a document used in an on-line environment. However, the process will be described herein since the process may be performed in support of the process of determining an access-right description.

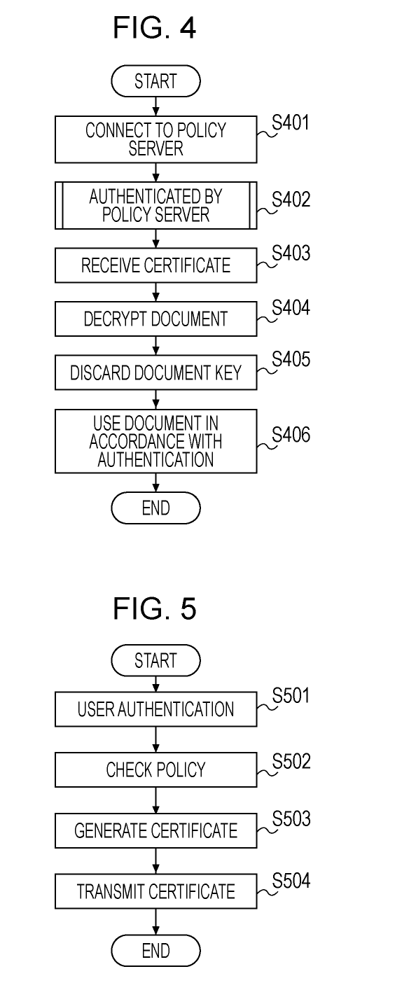

FIG. 4 is a flowchart illustrating an example of a process for accessing a document to which a policy is applied, and which is to be used in an on-line environment.

Note that, in this exemplary embodiment, a description is made assuming that a device which accesses to the document (that is, a subject which performs the process described with reference to FIG. 4) is the same as a device which applies the policy to the document (that is, a subject which performs the process described with reference to FIG. 3). That is, a description will be made assuming that a subject which performs the process of FIG. 4 corresponds to the client computer 102. Note that even when the subject which performs the process of FIG. 3 is different from the subject which performs the process of FIG. 4, the processes of FIGS. 3 and 4 may not be changed.

When the user inputs, to the policy controller 1022, an instruction for opening a document to which a policy is applied, the process described below is performed.

In step S401, the policy controller 1022 is connected through the network 101 to a policy server in order to access the document to which the policy is applied.

Note that the policy controller 1022 searches for the policy which is applied to the document and a policy server which stores the policy in accordance with the document license embedded in the document. Note that the document license includes the policy server identifying information and the policy information.

Note that in this exemplary embodiment, the policy server which is identified by the policy server identifying information corresponds to the policy server 103. Furthermore, the policy which is identified by the policy identifying information is the policy which has been associated with the policy identifying information and which has been stored in the policy server 103 in step S205.

Moreover, when the policy controller 1022 included in the client computer 102 is connected through the network 101 to the policy server 103, the policy controller 1022 may transmit a user ID and a password which are input by the user to the policy server 103.

In step S402, the policy server 103 performs authentication using the user ID transmitted from the policy controller 1022 included in the client computer 102.

When the authentication is successfully completed, the policy server 103 checks content of the policy which is identified (i.e., specified) by the policy identifying information and transmits a certificate file, which will be described hereinafter with reference to FIG. 5, to the policy controller 1022.

The operation of step S402 is described in detail in step S501 to step S504. FIG. 5 is a flowchart illustrating an example of a process of authenticating a policy performed using the policy server 103.

In step S501, the policy server 103 performs authentication (i.e., checks whether a correct password is input) using the user ID received from the client computer 102.

Then, the policy server 103 obtains the user information which is associated with the user ID and which is stored (e.g., in the policy server 103).

In step S502, the policy server 103 collates the obtained policy with the user information obtained in step S501 so as to check a right to access the document which is given to the user having the user ID (that is, an access right given to the user represented by the user information). Furthermore, the policy server 103 reads the document key stored in step S205 (that is, the document key which is associated with the policy) from an area in which the document key is stored.

In step S503, the policy server 103 generates a certificate file including the document key and the access right given to the user specified by the user information.

In step S504, the policy server 103 transmits the certificate file generated in step S503 to the client computer 102.

In step S403, the policy controller 1022 included in the client computer 102 receives the certificate file transmitted from the policy server 103 and starts accessing to the document.

In step S404, the policy controller 1022 decrypts the document corresponding to the certificate file using the document key included in the certificate file. After the decryption, the process proceeds to step S405.

In step S405, the policy controller 1022 discards the document key which was used to decrypt the document.

In step S406, the policy controller 1022 controls the access to the document in accordance with the access right included in the certificate file. That is, the policy controller 1022 is allowed to perform an operation in accordance with the access right.

The client computer 102 discards the certificate file after the document is accessed.

The process of accessing the document which should be used in the on-line environment may be controlled as described above.

Accordingly, an advantage of some aspects of the invention that an appropriate policy may be applied to a document which is generated by inputting data in a template, and which is to be viewed or printed using an arbitrary terminal. Therefore, the document to which the policy is applied may be quickly obtained, and security problems are less likely to arise.

In the first exemplary embodiment, when data is input in a field of a template to which a policy has not been issued, a detailed access right is determined in accordance with the data, and the policy is issued to a document in accordance with the detailed access right.

In a second exemplary embodiment, a case where input data is changed in a document will be described. In this case, it is likely that an access-right description corresponding to the changed data is different from an access right assigned before the data is changed. Even in this case, in order to enable a dynamic application of an appropriate policy without complicated operations, a policy issued based on the access-right description obtained after the data is changed can be assigned to the document.

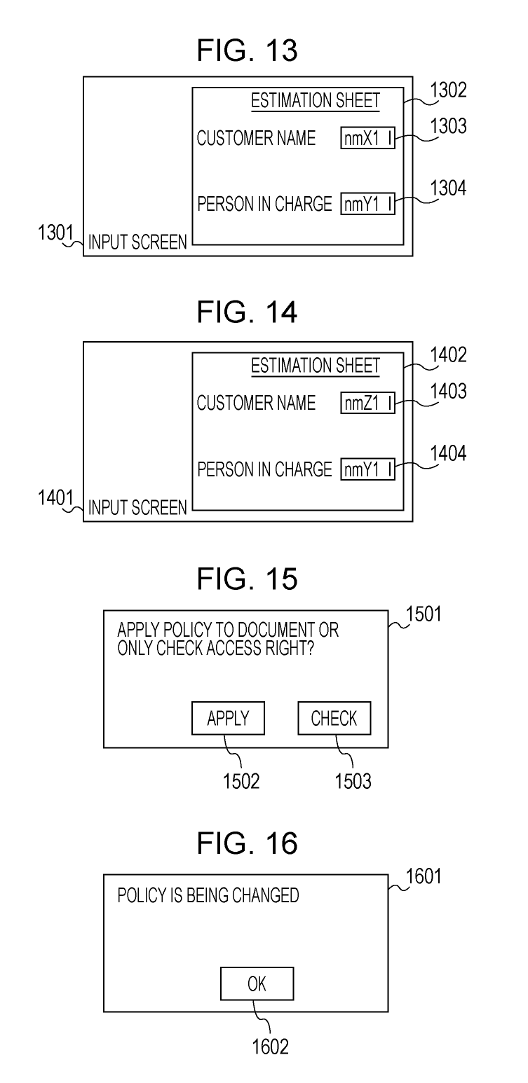

Referring to FIGS. 13 to 17, an example of a case where an access-right description obtained from an access-right determination server 104 is changed, in accordance with data input by a user before a policy is applied to a document, will be described.

In this case, a user interface can be changed in accordance with the change of the access right, and a control operation may be performed in accordance with a user's instruction while the instruction which is allowed to be issued by the user is controlled.

Examples of a series of these operations will be described.

FIGS. 13 and 14 show examples of input screens displaying documents obtained after the user inputs data.

Note that the data input screens may be obtained before a policy is determined.

FIG. 15 shows an example of a user interface used to determine whether the process proceeds to an operation of applying a policy determined in accordance with input data to the document, or the process proceeds to an operation of only checking an access right. With this interface, a selection instruction issued by the user can be received.

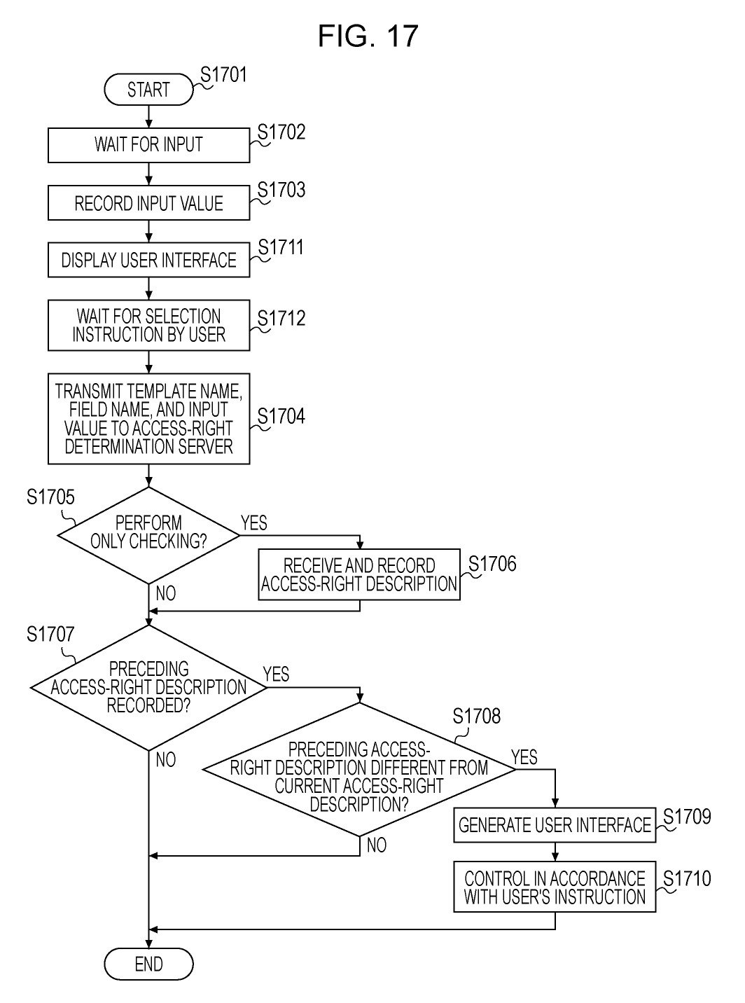

FIG. 16 shows an example of a user interface which may be used to notify that the policy is being changed, and the user can confirm the notification using the user interface.

FIG. 17 is a flowchart illustrating an example of a series of the operations described above. The series of the operations will be described with reference to FIG. 17.

First, the process starts in step S1701.

In step S1702, the display controller 1024 performs a display operation, as shown for example in FIG. 6, and waits for data input by the user.

FIG. 13 shows an example of an input screen 1301 in which data is input by the user, and the input screen 1301 includes a template 1302 of a document to be generated.

The template 1302 includes fields 1303 and 1304 which allow the user to input data and are in states in which data has been determined. After the data is input, the process proceeds to step S1703.

In step S1703, the input controller 1023 performs an operation of recording the data input by the user using the interface used for data input.

The display controller 1024 displays a message 1501 as shown for example in FIG. 15 in step S1711, and waits for an instruction issued by the user in step S1712.

In both cases where the user selects an instruction 1502 indicating that a policy corresponding to an access-right description to be received is applied, and where the user selects an instruction 1503 indicating that an operation of applying a policy is not performed but only an operation of checking an access-right description is performed, the process proceeds to step S1704.

In step S1704, as with the first exemplary embodiment, data, a template identifier which specifies the template 1302, and a field identifier which specifies a field to which the data is input are transmitted to the access-right determination server 104.

Then, a detailed access-right description is obtained from the access-right determination server 104.

In step S1705, it is determined whether the user's instruction issued in step S1712 indicates execution of the process of only checking the access-right description, or execution of the process of applying the policy to the document in accordance with the access-right description.

That is, in a case where the instruction 1502 indicating that the execution of the process of applying the policy is received, a policy is newly issued for the document in accordance with the new access-right description.

On the other hand, in a case where the instruction 1503 indicating that the execution of the process of only checking the access-right description is received, a policy is not newly issued and only the process of checking the access-right description is performed.

When it is determined that the process of only checking the access-right description is to be performed (YES in step S1705), processing proceeds to step S1706 where the access-right description is received and recorded. If it is determined that the process of only checking the access-right description is not to be performed (NO in step S1705), processing proceeds to step S1707.

In step S1707, it is determined whether a preceding access-right description has been recorded.

When it is determined that the preceding access-right description has been recorded (YES in step S1707), the process proceeds to step S1708 where content of the current access-right description and content of the preceding access-right description are compared with each other.

That is, in a case where another access-right description has been applied before, the content of the current access-right description and the content of the preceding access-right description are compared with each other. If it is determined that the preceding access-right description had not been recorded (NO in step S1707), processing is ended.

When the two access-right descriptions are different from each other, the policy is changed. Therefore, when the two access-right descriptions are different (YES in step S1708), processing proceeds to step S1709 where a user interface is generated in accordance with the difference. When the two access-right descriptions are not different (NO in step S1708), processing is ended.

FIG. 16 shows an example of the user interface including a message 1601 indicating that the policy to be applied to the document should be changed due to the difference between the two access-right descriptions.

The user interface includes a button 1602 used when the user performs confirmation.

In step S1710, an operation is performed in accordance with the user's instruction.

That is, when the process of only checking the access-right description is selected in step S1705, the policy is not changed, whereas when the process of applying the policy is selected, the policy is changed.

Note that although the access-right descriptions are compared with each other in step S1707 and step S1708, this comparison may also be eliminated. That is, every time new data is input to a field and therefore the data included in the field is changed, an access-right description for the changed data may be received.

Referring to FIGS. 13 and 14, the operation performed in step S1707 will be described in detail.

A template input screen 1401 which is similar to the input screen 1301 includes a template 1402 which is similar to the template 1302. The template 1402 includes fields 1403 and 1404 which are similar to the fields 1303 and 1304. Note that data input in the field 1303 is different from data input in the field 1404.

Assuming that an access-right description obtained from the access-right determination server 104 in accordance with the input data shown in FIG. 13 is referred to as a “preceding recorded access-right description”, the preceding recorded access-right description is compared with a current access-right description obtained from the access-right determination server 104 in accordance with the input data shown in FIG. 14 (step S1708).

In this case, since data input in the field 1303 is different from data input in the field 1403, the two access-right descriptions are different from each other. In this case, the process proceeds to step S1709.

As described above, when new data is input and therefore the data input in the template is changed after a certain policy is issued, the access-right description may also be changed in accordance with the change of the input data.

The client computer 102 may newly request the policy server 103 to issue another policy in accordance with the changed access-right description. After receiving the request, the policy server 103 can newly issue another policy for the document in which the input data is changed.

Accordingly, an appropriate policy may be dynamically applied to a document generated in an on-demand manner, such as in a case where different users input different data items in a field of the template, for example, without complicated operations.

In this case, a plurality of possible combinations of a type of field of the template and data to be input to the field can be considered. However, in any case, an appropriate policy can be issued.

Accordingly, the complicated operations for a system administrator, such as an operation of checking content of each document and applying a policy, may be substantially avoided.

In the first and second exemplary embodiments, information for determining an access-right description is obtained, and a policy can be applied to a document in accordance with an access right.

In a third exemplary embodiment, a process that may be performed when such information for determining an access-right description is not obtained will be described.

Note that this exemplary embodiment may also be employed simultaneously with the first and second exemplary embodiments.

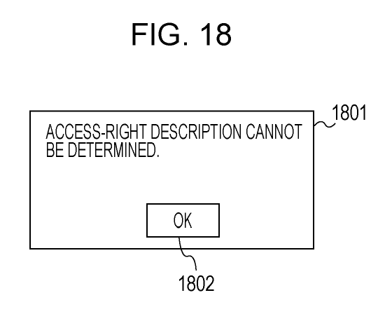

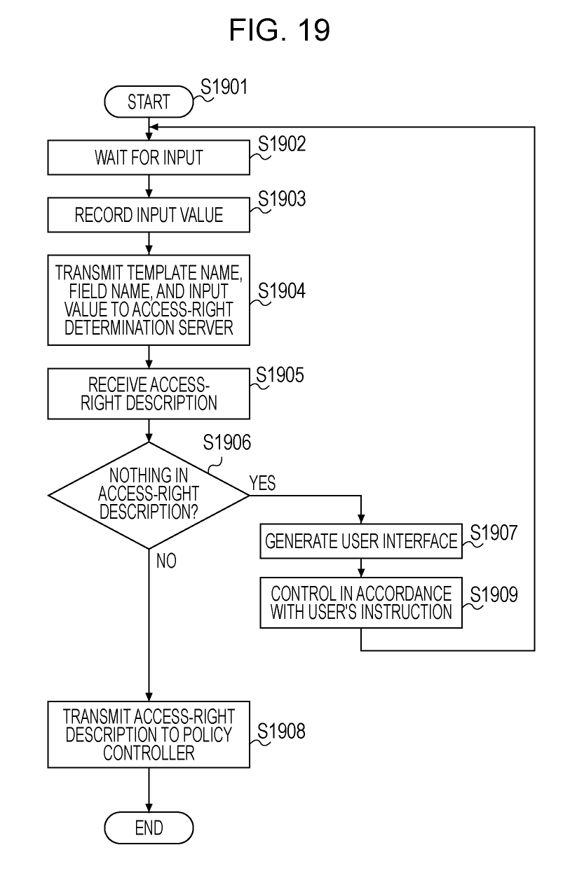

Referring to FIGS. 18 and 19, the process performed when information for determining an access-right description is not obtained will be described.

FIG. 18 shows an example of a user interface which displays a message indicating that the access-right description cannot be determined, and which is used to perform confirmation by the user.

FIG. 19 is a flowchart illustrating an example of this process.

Referring to FIG. 19, the process performed when information for determining an access-right description cannot be obtained will be described.

First, the process starts in step S1901.

In step S1902, a display controller 1024 performs a display operation as shown for example in FIG. 6, and waits for data input by the user.

For example, the user can input data in fields 603 and 604 included in an input screen 601. After the data is determined, the process proceeds to step S1903.

In step S1903, the data input by the user is recorded.

In step S1904, the input data, a template identifier which specifies a template, and a field identifier which specifies a field to which the data is input are transmitted to an access-right determination server 104.

Here, the access-right determination server 104 may perform the process of determining an access-right description described above. When the access-right description cannot be determined, it is determined that the access-right description is blank.

The access-right description is received in step S1905, and it is determined whether the access-right description is blank in step S1906.

When it is determined that the access-right description is blank in step S1906 (YES in step S1906), a message 1801 is displayed and processing proceeds to step S1907 where a user interface including a button 1802 used for instruction of a confirmation is generated.

When the user instructs a confirmation in step S1909, the data input screen is displayed again, and processing returns to step S1902.

When it is determined that the access-right description is not blank in step S1906 (NO in step S1906), processing proceeds to step S1908 where the access-right description is transmitted to the policy controller 1022. The process is thus terminated.

Note that information to be transmitted to the client computer 102 when the access-right determination server 104 cannot obtain the access-right description may not necessarily be blank. Any data having a format similar to the information may be employed.

According to this exemplary embodiment, when appropriate data is not input in the field of the template, it is possible to prevent a policy from being issued or it is possible to perform a notification which prompts the user to input appropriate data.

In a fourth exemplary embodiment, a setting for enabling a function of dynamically determining an access-right description will be described.

The fourth exemplary embodiment may be used simultaneously with any of the foregoing first to third exemplary embodiments.

Referring to the example shown in FIG. 10, a setting performed for using an access-right determination server 104 will be described.

A setting screen 2001 includes a switch 2002 used to determine whether the access-right determination server 104 is to be used.

When it is determined that the access-right determination server 104 is to be used, an inquiry is made to the access-right determination server 104 about an access-right description.

On the other hand, when it is determined that the access-right determination server 104 is not used, an access-right description is not obtained and a policy is not applied to a document generated on the basis of a template.

The setting screen 2001 includes a menu 2003 used to select one of the templates, and a region 2004 including fields for a template selected using the menu 2003.

It is assumed that a type of template selected in the menu 2003 is an “estimation sheet”, and the user intends to input data in fields 603 and 604 in an input screen 601 shown in FIG. 6. In this case, an identifier which identifies the selected template, and an identifier which identifies the field which is selected in the region 2004, correspond to information to be transmitted to the access-right determination server 104.

According to this exemplary embodiment, an administrator can determine whether the function of dynamically determining an access-right description for a document generated on the basis of a template is set.

Furthermore, since a type of the field identifier which is referred to when the administrator determines an access-right description can be selected, from among a plurality of data items, a data item which should be referred to when an access-right description is determined can be determined.

As described above, since a field which is referred to when an access-right description is determined is selected, a policy appropriate for a document may be issued while taking an intention of the administrator into consideration.

A processing method for storing, in a recording medium, a program and/or computer-executable instructions used to operate the configurations described in the foregoing exemplary embodiments so that the functions of the foregoing exemplary embodiments are realized, reading the program and/or computer-executable instructions stored in the recording medium, for example as code, and executing the program and/or computer-executable instructions using a computer, for example via a CPU, are included in the foregoing exemplary embodiments. Furthermore, the recording medium which stores the program may also be included in the foregoing exemplary embodiments.

Examples of the recording medium include at least one of a floppy (registered trademark) disk, a hard disk, an optical disc, a magneto-optical disk, a CD-ROM (Compact Disc Read-Only Memory), a magnetic tape, a nonvolatile memory card, and a ROM.

Furthermore, in addition to the recording medium having the program and/or computer-executable instructions which is stored therein and which may be used to perform an operation, computer-readable recording media with programs and/or computer-executable instructions which operate in an OS (Operating System), and which are used to execute the processes according to aspects of the foregoing exemplary embodiments, are also included in the foregoing exemplary embodiments.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-149364 filed Jun. 6, 2008, which is hereby incorporated by reference herein in its entirety.

What is claimed is:

1. A document management apparatus included in a document management system having a policy server which issues a policy corresponding to a right to access a document, the document management apparatus comprising:
an access-right description determination unit configured to collate first data input in the document with an access-right description defined in accordance with second data input in the document in advance, and determine the access-right description for the document in which the first data is input in accordance with a result of the collation;
a requesting unit configured to request the policy server to issue the policy in accordance with the access-right description determined using the access-right description determination unit; and
an applying unit configured to apply the policy issued by the policy server to the document in which the first data is input.

2. The document management apparatus according to claim 1,
wherein the access-right description is defined in accordance with the second data which is input in the document management apparatus in advance, data representing an identifier of a template which is used to generate the document to which the second data is input, and data representing a field identifier, and includes the right to access the document.

3. The document management apparatus according to claim 1, comprising:
an access-right description changing unit configured to, when input data is changed, collate the changed data, data which associates with the document to which the data is input, and content of the access-right description defined in accordance with the second data input in the document in advance, and change the access-right description for the document in which the input data is changed in accordance with a result of the collation;
a re-requesting unit configured to request the policy server to reissue the policy in accordance with the access-right description changed using the access-right description changing unit; and
a determination unit configured to determine whether the policy obtained by making a request using the re-requesting unit is to be applied to the document in which the input data is changed.

4. The document management apparatus according to claim 3, further comprising:
a determination unit configured to determine whether the access-right description obtained before the input data was changed is different from the access-right description which is changed using the access-right description changing unit,
wherein when the determination unit determines that the access-right description obtained before the input data was changed is different from the access-right description which is changed using the access-right description changing unit, the policy server is requested to reissue the policy in accordance with the access-right description changed using the access-right description changing unit.

5. The document management apparatus according to claim 1,
wherein when the request of the issuance of the policy to the policy server is not performed, an instruction which prompts a user to perform an input operation is displayed or an operation of requesting the issuance of the policy is terminated.

6. The document management apparatus according to claim 1, further comprising:
a field selection unit configured to select a type of field to be referred to when the access-right description is determined.

7. The document management apparatus according to claim 1,
wherein a display is provided which prompts a user to determine whether the access-right description determination unit is to be used.

8. A policy server which is included in a document management system having a document management apparatus and which issues a policy corresponding to a right to access a document, the policy server comprising:
a reception unit configured to receive data which is input in the document using the document management apparatus, data representing an identifier of a template which is used to generate the document to which the data is input, and data representing a field identifier;
an access-right description determination unit configured to collate the data received using the reception unit with an access-right description defined in accordance with data input in the document in advance, and determine the access-right description for the document in which the data is input in accordance with a result of the collation; and
an issuing unit configured to issue the policy to the document management apparatus in accordance with the access-right description determined using the access-right description determination unit.

9. A document management method employed in a document management system having a document management apparatus and a policy server which issues a policy corresponding to a right to access a document, the document management method comprising:
collating first data input in the document with an access-right description defined in accordance with second data input in the document in advance, and determining the access-right description for the document in which the first data is input in accordance with a result of the collation;
requesting the policy server to issue the policy in accordance with the determined access-right description; and
applying the policy issued by the policy server to the document in which the first data is input.

10. The document management method according to claim 9,
wherein the access-right description is defined in accordance with the second data which is input in the document management apparatus in advance, data representing an identifier of a template which is used to generate the document to which the second data is input, and data representing a field identifier, and includes the right to access the document.

11. The document management method according to claim 9, comprising:
collating, when input data is changed, the changed data, data which associates with the document to which the data is input, and content of the access-right description defined in accordance with the second data input in the document in advance, and changing the access-right description for the document in which the input data is changed in accordance with a result of the collation;
requesting the policy server to reissue the policy in accordance with the changed access-right description; and
determining whether the policy obtained by making a request to reissue the policy is to be applied to the document in which the input data is changed.

12. The document management method according to claim 11, further comprising:
determining whether the access-right description obtained before the input data was changed is different from the changed access-right description,
wherein when it is determined that the access-right description obtained before the input data was changed is different from the changed access-right description, the policy server is requested to reissue the policy in accordance with the changed access-right description.

13. The document management method according to claim 9,
wherein when the request of the issuance of the policy to the policy server is not performed, an instruction which prompts a user to perform an input operation is displayed or an operation of requesting the issuance of the policy is terminated.

14. The document management method according to claim 9, further comprising:
selecting a type of field to be referred to when the access-right description is determined.

15. The document management method according to claim 9,
wherein a display is provided which prompts a user to determine whether the access-right description determination unit is to be used.

16. A method for controlling a policy server which is included in a document management system having a document management apparatus and which issues a policy corresponding to a right to access a document, the method comprising:
receiving data which is input in the document using the document management apparatus, data representing an identifier of a template which is used to generate the document to which the data is input, and data representing a field identifier;
collating the received data with an access-right description defined in accordance with data input in the document in advance, and determining the access-right description for the document in which the data is input in accordance with a result of the collation; and
issuing the policy to the document management apparatus in accordance with the determined access-right description.

17. A computer-readable recording medium having computer-executable instructions stored thereon for causing a document management apparatus, which is included in a document management system having a policy server which issues a policy corresponding to a right to access a document, to execute a document management method, the computer-readable recording medium comprising:
computer-executable instructions for collating first data input in the document with an access-right description defined in accordance with second data input in the document in advance, and determining the access-right description for the document in which the first data is input in accordance with a result of the collation;
computer-executable instructions for requesting the policy server to issue the policy in accordance with the determined access-right description; and
computer-executable instructions for applying the policy issued by the policy server to the document in which the first data is input.
